(19) United States
(12) Patent Application Publication
(10) Pub. No.: US 2022/0171762 A1
(43) Pub. Date: Jun. 2, 2022

(54) Methods Circuits Systems and Functionally Associated Machine Executable Code to Manage, Augment, Meta-Tag and Search Digital Content

(71) Applicant: Haim Ezer, Ramat Gan (IL)

(72) Inventor: Haim Ezer, Ramat Gan (IL)

(21) Appl. No.: 17/106,215

(22) Filed: Nov. 30, 2020

(51) Int. Cl. G06F 16/23; H04L 9/32

(52) U.S. Cl. CPC G06F 16/2379; H04L 9/3263

(57) ABSTRACT

The present application relates to methods, circuits, devices, systems and functionally associated machine executable code for context and content related meta-tagging of audio/video content. The meta-data tagging or embedding may be used, for example, to enable ease of searching, relevance matching and retrieval for a content consumer. A digital content processing system according to embodiments may include a digital content augmentation module to identify one or more content elements in different segments of the content and to embed into the digital content meta-data indicating location of identified content elements within the digital content and a content commentary based augmentation module to use commentary about the digital content to generate meta-data which is embedded within the digital content. Searching according to embodiments may include providing terms related to sought after content, posing specific questions, or by otherwise indicating parameters of interest related to the content.

### FIELD OF THE INVENTION

The present invention generally relates to the fields of content production, augmentation, distribution and management. More specifically, the present invention relates to methods, circuits, devices, systems and functionally associated machine executable code for context and content related meta-tagging of audio/video content, for example for providing ease of searching, relevance matching and retrieval for a content consumer searching content by posing specific questions or otherwise indication parameters of interest.

### BACKGROUND

The first digital encoding of human speech, in PDM format, was proposed by a British scientist in the 1930's. Audio/Video recordings of human speech and actions became prevalent by the 1970's. Content production and recording by individuals and groups exploded after the massive spread and adoption of the Internet in the 1990's. The internet has become the ultimate repository and distribution means for the world's content producers.

As of the date of 2020, the year this application is being written, in is estimated that the digital universe consists of over 44 zettabytes of digital content. By 2025, the amount of data generated each day is expected to reach 463 exabytes globally.

Although much of the uploaded data is technically “accessible” to everyone with access to the internet, the sheer ginormous volume of data stored in an unclassified and unorganized manner leads to situations where people looking for specific content usually have issues finding the specific content, even after using universally available search engines and portals such as Google, Yahoo, etc. A few meta-tags associated with specific content which tags only include a title or other specific words relating to the specific content are usually insufficient to significantly distinguish, highlight and separate the specific content from the “other: content with one or more similar attributes to the specific content. Searches for the specific content only using the keyword or the metatags mentioned above usually leads to the “other” content appearing responsive to searches with specific search terms directed towards the specific content. Even if the desired content appears responsive to the search, it is usually flanked and obscured by the “other” content. This information overload phenomenon can and is sometimes exploited by individuals and groups attempting to hide specific information “in-plain-sight”, by uploading a barrage of similar sounding, but totally unrelated, content which will appear in search engine results when search terms for the specific content are entered into the search engine.

Even without intentional obscuring of content being a factor, finding specific relevant content addressing an immediate concern or question requires searching skills and tools most regular internet users do not possess. This issue affects both content consumers and content producers who which monetize their produced content.

Many content producers wish to monetize or otherwise gain benefit from making their content accessible to interested parties over the internet, but find it difficult to get the attention, or even to be found, by the relevant target market. Search Engine Optimization (SEO) techniques used by SEO service providers are usually crude and in many cases fail to adequately distinguish the content from the vast universe of unrelated noise.

There is a need in the field of content management, including online storage and distribution, for improved content characterization and tagging for searchability purposes. There is a need for improved content storage, search and retrieval technologies which provide to a content consumer, seeking information or opinions about a specific subject or question, relevant available content correlated to the sought after information or opinion in an efficient manner and within a relevant time-frame.

### SUMMARY OF INVENTION

The present invention includes methods, circuits, devices, systems and functionally associated machine executable code to manage, augment, meta-tag and search digital content. According to embodiments of the present invention there may be provided an audio/video content processing system to process and augment content recorded from or otherwise produced by a content creator, amateur or professional, prior and following publication of the content. Examples of digital content according to the present invention include locally stored and online publications of lectures, sermons or other subject specific presentations including embedded meta-tags, meta-data, transcripts, commentary, term index tables, one or more digital certificates authenticating content or comment authorship and/or viewership parameters (e.g. list or characterization of digital content viewers). Accordingly, the audio/video content processing system according to embodiments of the present invention may be integral or otherwise functionally associated with: (a) artificial Intelligence (AI) based feature/meaning extractors; (b) content editing along with meta-data tagging modules; (c) online content publishing and editing modules and optionally web accessible content storage; (d) a content player with consumer feedback capture and logging functionality; (e) content search modules; (f) a natural language processing engine for generating questions whose answer matches search terms for available digital content, and vice versa ; and (g) content recommendation engines or modules.

According to embodiments, prior to publishing or republishing of any given content, the content production system may embed or meta-tag the “to be (re)published” content with some combination of: (a) content descriptive metadata; (b) content creator commentary; and/or (c) content consumer feedback, verbally or otherwise generated. The content production system may also provide for the embedding of one or more digital certificates authenticating a source of embedded meta-data. The certificate may be used to authenticate either a content producer, a content meta-tagger, a content viewer who provided feedback and or any third party with permission to add meta-data or meta-tags to the content. A digital certificate according to embodiments of the present invention may also provide and or authenticate parameters such as location, date and/or time of content production and/or meta-data tagging. A private/public key combination or the like may be used for digital certificate tagging/embedding and/or subsequent authentication.

A digital content player according to embodiments of the present invention may be configured to, while running on a computing platform, receive and audio/video render digital content according to embodiments of the present invention. According to further embodiments, the digital content player may be configured to, while playing digital content, receive or otherwise sample feedback from a content consumer (e.g. viewer or listener) via one or more user inputs and/or one or more sensors of the computing platform. Feedback according to embodiments of the present invention may be in the form of written or spoken comments and/or digitized samples of a content consumer utterances or movements captured by one or more sensors of the digital content player according to embodiments of the present invention. The feedback may be in the form of digitized audio and/or video captured of a content consumer's reactions to the playing of the digital content as sampled and digitized by one or more sensor. The feedback may be in the form of a characterization of the content consumer's reactions to the playing of the digital content. According to some embodiments, the meta-data, meta-tags, the feedback and all other data added to or embedded with the original digital content may propagate along with the digital content itself as the content is viewed from and copied to various locations.

According to some embodiments, before, during or after initial distribution of some digital content according to the embodiment, the digital content may be autonomously meta-tagged by a content processing system according to embodiments of the present invention. Autonomous meta-tagging may include a first step of auto-transcribing verbal content into a written transcript using one or more speech to text algorithms, speech-to-text engines and or phrase tables for ambiguity separation. Additionally, according to embodiments of the present invention where the digital content may be video with audio, autonomous digital content meta-tagging may include a videoframe/image feature extractor adapted to identify visual features and subject in the scene. The videoframe/image feature extractor according to embodiments of the present invention may be functionally coupled to a subject (i.e. person) tracker, gesture identifier and activity characterization module.

Outputs from the extractor and functionally associated tracker, identifier and characterization module may be encoded using plain linguistic terms (e.g. English, Spanish, etc.) corresponding to the tracked subjects' detected activities and gestures. Specific encoded output may be appended to the digital content according to embodiments of the present invention along with indicators of where specifically in the digital content (e.g. timestamp and/or which content segment) was the source of the specific encoded extractor, tracker, detector and characterization outputs. Appending visually extracted characterization meta-tags may provide search terms pointing to specific content segments where specific subject, jestures and/or actions a presented in the digital content according embodiment of the present invention. To the extent that visually extracted meta-data can be interpreted to indicate a subject's emotional state or other dynamic attribute, that visually extracted data may be used to search for, from within the digital content, content segments corresponding to specific emotional states and other dynamic attributes.

According to further embodiments, actual meaning or messages contained within different segments of the published content may also be extracted, extrapolated or otherwise derived using various natural language processing engines which may apply various AI models or techniques. Content meaning extracted and or otherwise derived from digital content according to embodiments of the present invention may be appended to the content as searchable meta-data or meta-tags. The searchable meta-data may provide or otherwise indicate one or more content locations or content segments from which the meta-data was derived, thereby providing search terms corresponding to meanings of specific content segments according embodiment of the present invention.

Search terms o digital content or content segments according to embodiments of the present invention may be multi-factored, including specifics about actual content elements, content creator or third party commentary regarding content elements, content consumer feedback regarding content elements or content segments, and or possibly automatically detected reactions by content consumers or other third parties to content viewing. An example of a content search made possible by embodiments of the present invention, could be “a content segment including a subject singing or dancing and some number of content consumers laughing in response to exposure to that content segment.”

According to embodiments of the present invention, an AI model and/or engine may be used to establish a “cause and effect” relationship between triggers and results which are declared, sensed, described or started within input to the model or engine. For example, the phrase early to bed and early to rise makes a man healthy, wealthy and wise may be parsed to correlate an early bedtime and/or an early risetime with a set of results including happiness, health and wealth. This correlation can be transformed and encoded into searchable terms the content segment including the exemplary phrase. Using a natural language processor adapted to convert search terms with specific results, such as one or more search terms like “what makes a person happy? How does someone start saving money?”

Digital content according to embodiments of the present invention may include or be otherwise functionally associated search term indexes. These indexes may be compiled and or edited by one or more applications associated with the content processing system of the present invention. The index may include multi-factor search terms of various formats, including content description and or content corresponding, responsive to, or otherwise associated with a specific question or with specific question types. The content index may be encoded or otherwise embedded with the main content of the digital content file, data structure or object.

According to further embodiments, there may be provided a digital content search engine to identify digital content, and segments of digital content, based on the composite, multi-factor, meta-data, including content descriptions and consumer feedback, A digital content player according to embodiments of the present invention may be configured to search for requested content, either by search term or by search question format.

There may be provided, according to embodiments, one or more online directories of search terms and corresponding to digital content according to embodiments of the present invention, along with indicators of online locations of specific digital content. Each digital content's associated search terms, for the respective content and for segments of the respective content, can also be encoded and or otherwise embedded with the respective digital content.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the folio wing detailed description when read with the accompanying drawings in which:

FIG. 1 is a functional block diagram of an exemplary content processing and distribution system according to embodiments of the present invention;

FIG. 2 is an illustration of an exemplary digital content data structure according to embodiments of the present invention; and

FIG. 3 is a symbolic illustration of an exemplary digital content authoring and management application according to embodiments of the present invention;

FIG. 4 is a symbolic illustration of an exemplary digital content player and response sampler application according to embodiments of the present invention; and

FIG. 5 is a network level diagram illustrating the relative arrangement block diagram of a digital content player, with search engine functionality, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. hi other instances, ell-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like. Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or sold state memory, magnetic tape, a removable computer diskette, a random access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk-read only memory (CD-ROM), compact disk read/write (CD-R/W), and DVD.

in some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other functionally suitable components may be used.

Embodiments of the present invention may include a digital content processing system comprising a digital content augmentation module to identify one or more content elements in different segments of the content and to embed into the digital content meta-data indicating the location of identified content elements within the digital content. The system may also include a content commentary based augmentation module to convert commentary, from an author or a content consumer, about the digital content or about a specific segment of the digital content, into meta-data which is embedded within the digital content. The digital content processing system may also include a content consumer response feedback augmentation module which embeds in the digital content meta-data based on content consumer feedback from viewing the digital content. The content consumer feedback may be provided by each of one or more content consumers through corresponding content players which provide user interfaces and programmatically prompt users to provide feedback. The content consumer feedback may be a machine generated characterization of one or more responses of a content consumer when they are exposed to the digital content being played. The content processing system's augmentation modules may perform digital certificate tagging of content comments or other embedded metadata in order to provide a means of authenticating comments and other meta-data sources, dates and or locations.

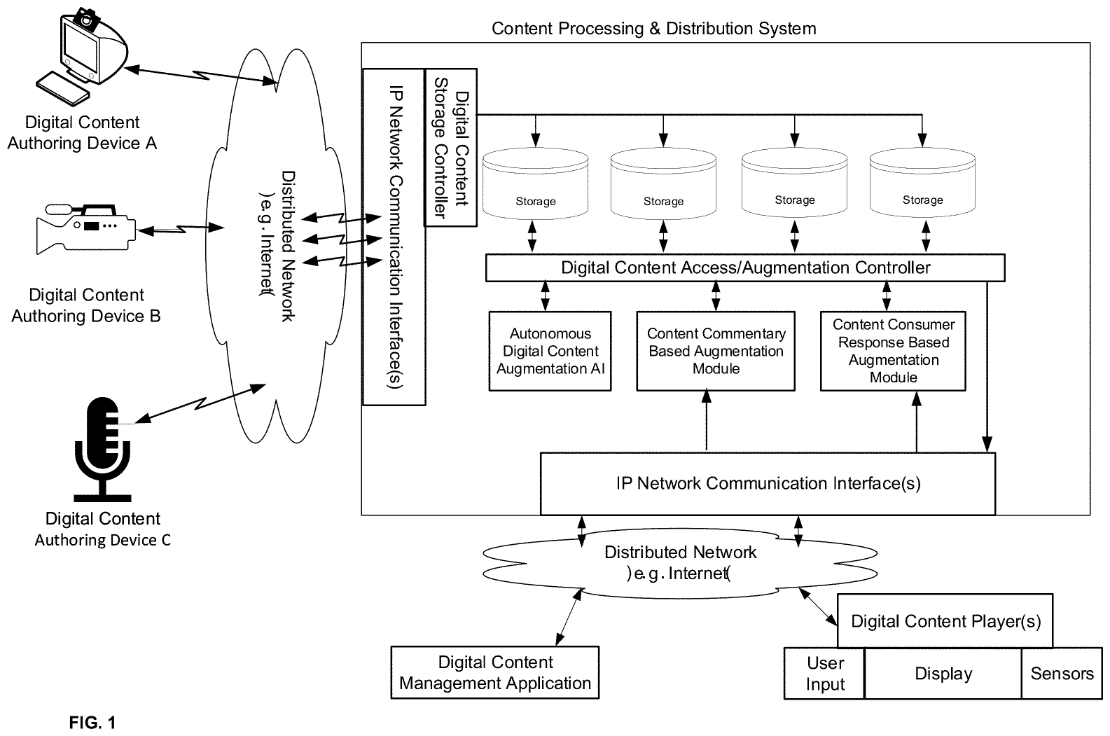

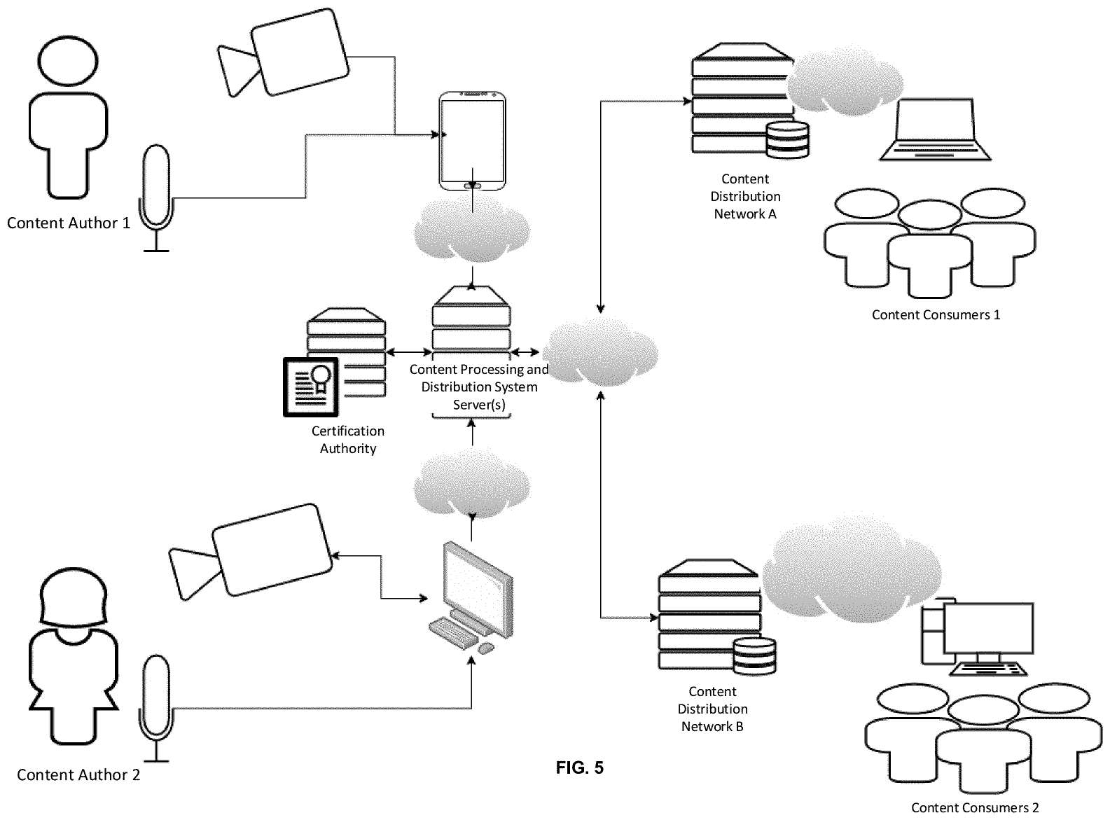

Turning now to FIG. 1, there is shown a functional block diagram of an exemplary content processing and distribution system according to embodiments of the present invention. The illustrations shows multiple scene capture devices used to generate digital content streamed to a content processing system in accordance with embodiments of the present invention. Content consumers may be able to access content from storage of the processing system or from content distribution networks (see FIG. 5) to which the processing and distribution system may feed uploaded content. Digital content stored in the storage of the system may be augmented by the author and third parties. Augmentation may include direct comments and or characterizations of responses (smile, laugh, frown, cry, etc.) of people exposed to the digital content.

The response-based content augmentation module of FIG. 1 may include one or more neural networks operating using models designed and trained to classify human responses captured on video or in audio. Digital content players according to embodiments may use video and or audio input sensors on host devices to capture responses of content consumers. The players may also access standard interfaces of host devices and prompt content consumers to provide direct feedback.

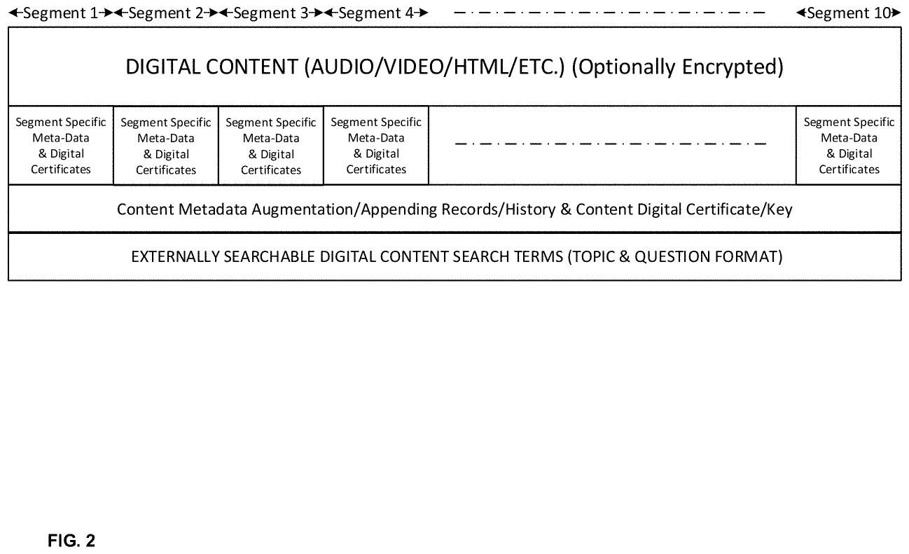

Turning now to FIG. 2, there is an illustration of an exemplary digital content data structure according to embodiments of the present invention. The data structure can be encoded and or encapsulated in a variety of data formats, known today or to be devised in the future. Various subsets or extensions of this data structure may be applicable to the present invention.

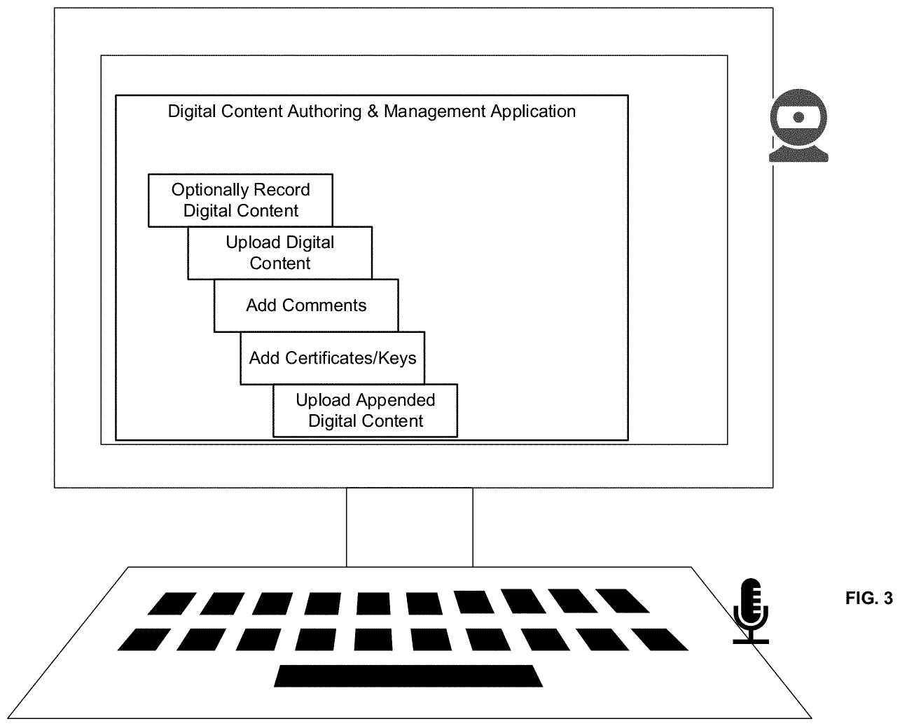

Turning now to FIG. 3, there is shown a symbolic illustration of an exemplary digital content authoring and management application according to embodiments of the present invention. All the functionality provided by the application is listed therein and may be utilized by a content author or third party interested in augmenting stored digital content managed within the system. The management application may also be used to distribute digital content to one or more content distribution networks, as seen in FIG. 5. The management application may also be used to manage digital certificates relating to embedded comments and/or feedback from content consumers. The management application may also be used to maintain version control continuity across distribution nodes as comments and or responses add and embedded in to the digital content after initial publication.

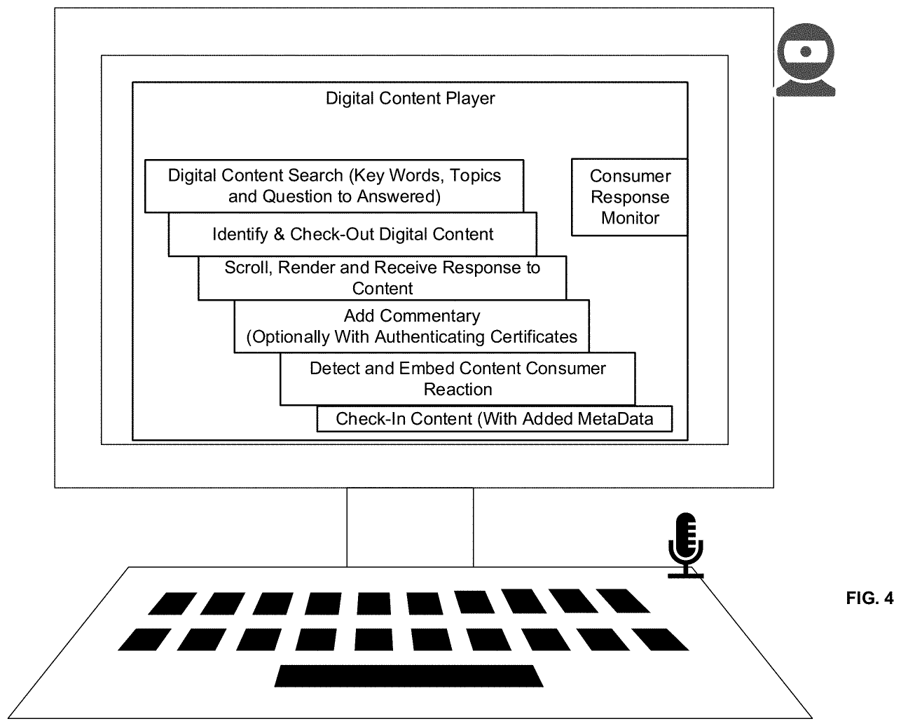

Turning now to FIG. 4, there is shown a symbolic illustration of an exemplary digital content player and response sampler application according to embodiments of the present invention. This player may include audio/video rendering functionality and may also sample viewer/listener response. The sampled response information may be sent back to the system for machine characterization and metadata embedding.

Turning now to FIG. 5, there is shown a network level diagram illustrating the relative arrangement block diagram of a digital content player, with search engine functionality, according to embodiments of the present invention. This illustration includes authoring devices connected to the system according to embodiments of the present invention over internet gateways, mobile and landline. Digital content is authored, augmented, certified, and distributed to one or more content distribution networks accessible by content consumers using content players according to embodiments of the present invention. The content player of FIG. 4 may include content search functionality operating through the use of digital content characterization queries and or factual question queries.

The processes and displays presented herein are not inherently related to any particular computer, device, system or other apparatus. Various general purpose systems may be used with programs in accordance with the teachings herein, or it may prove a more convenient to construct specialized apparatus to perform the desired method. The desired structure for a variety of these systems will appear from the description below, In addition, embodiments of the present invention are not described with reference to any particular programming language. It will be appreciated that a variety of programming languages may be used to implement the teachings of the inventions as described herein.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A digital content processing system comprising:
a digital content augmentation module to identify one or more content elements in different segments of the content and to embed into the digital content meta-data indicating location of identified content elements within the digital content;
a content commentary based augmentation module to use commentary about the digital content to generate meta-data which is embedded within the digital content.

2. The digital content processing system according to claim 1 further comprising a content consumer response feedback augmentation module which embeds in the digital content meta-data generated based on content consumer feedback to viewing the digital content.

3. The digital content processing system according to claim 2, wherein the content consumer feedback is provided by each of one or more content consumers through corresponding content players which provide user interfaces and programmatically prompt users to provide feedback.

4. The digital content processing system according to claim 2, wherein the content consumer feedback is a machine generated characterization of one or more responses of a content consumer when they are exposed to the digital content being played.

5. The digital content processing system according to claim 1, wherein said commentary augmentation module performs digital certificate tagging of content comments or other metadata in order to provide a means of authenticating comments and other meta-data sources, dates and or locations.
